(19) United States
(12) Patent Application Publication
(10) Pub. No.: US 2016/0188802 A1
(43) Pub. Date: Jun. 30, 2016

(54) APPARATUS AND METHOD FOR MANAGING MEDICAL DATA BASED ON CARE PROVIDING SITE VISIT OF USER

(71) Applicant: LG CNS CO., LTD., Seoul (KR)

(72) Inventors: Hyunjun KIM, Seoul (KR); Young jin LEE, Seoul (KR); Jeong-Nam KWON, Seoul (KR); Seongsoo KIM, Seoul (KR); Youngkook KIM, Seoul (KR); Jee Hyun KIM, Seoul (KR); Si Young PARK, Seoul (KR); Jae Won PARK, Seoul (KR); Jaemin SUHL, Seoul (KR); Kihwan CHOI, Seoul (KR); Wonjae CHOI, Seoul (KR)

(73) Assignee: LG CNS CO., LTD., Seoul (KR)

(21) Appl. No.: 14/584,983

(22) Filed: Dec. 29, 2014

(51) Int. Cl. G06F 19/00; G06F 17/30

(52) U.S. Cl. CPC G06F 19/322; G06F 17/3097; G06F 19/325

(57) ABSTRACT

An apparatus and method for managing medical data based on a care providing site visit of a user are disclosed. The method of managing the medical data may include collecting medical data from a care providing site server associated with at least one care providing site, identifying a user included in the medical data, and managing the medical data by care providing site visit of the user visiting the care providing site.

### BACKGROUND

1. Field of the Invention

The present invention relates to an apparatus and method for managing medical data, and more particularly, to an apparatus and method for unifying and managing medical data created in a plurality of care providing site servers associated with a plurality of care providing sites.

2. Description of the Related Art

A user or patient may go to different care providing sites for the same type of disease. For example, the user may go to a care providing site near a house or may go to a care providing site near on office depending on the user's location and schedule. Further, the user may go to a clinic first and then go to a general care providing site, or the user may go to a different care providing site because of unsatisfactory treatments received at the general care providing site.

When the user visits different care providing sites, the user may not remember all of the care providing sites that the user visited. However, medical data created by the care providing sites that the user visited may be required by another care providing site that the user visits later. Thus, there is a need for a method of providing medical data previously created at different care providing sites to a new care providing site that the user visits.

Medical insurance fees are determined based on a number of times medical bills are covered by a medical insurance company, and thus, the medical insurance company keeps track of a count of care providing site visits by the user. However, conventional medical data have been created by the user, and thus, it has been impossible to determine exactly how many times the user had visited at least one care providing site. Thus, a method for determining a total number of care providing site visits by the user needs to be provided.

### SUMMARY

An aspect of the present invention provides a system and method capable of easily determining a count of care providing site visits by a user by checking a care providing site visit by the user and creating new medical data whenever the user visits the care providing site.

Another aspect of the present invention provides a system and method capable of easily determining a count of care providing site visits by a user by managing medical data based on care providing site visits by the user.

Still another aspect of the present invention provides a system and method capable of unifying and managing medical data created when the user visits different care providing sites, and providing a care providing site that the user visits with medical data created by all care providing sites including other care providing sites, thereby allowing sharing of the medical data of the user among different care providing sites.

Yet another aspect of the present invention provides a system and method capable of converting medical data created by different care providing site servers into unified medical data in accordance with a standard format and managing the medical data when different care providing sites use different formats of medical data, thereby allowing easy understanding of contents of medical data written in a different format by another care providing site.

According to an aspect of the present invention, there is provided a method of managing medical data, the method including collecting medical data from a care providing site server associated with at least one care providing site, identifying a user included in the medical data, and managing the medical data by care providing site visit of the user visiting the care providing site.

The managing may include retrieving the medical data collected by the care providing site server and medical data collected by a care providing site server of a different care providing site from the care providing site when the care providing site server requests the medical data, and providing the retrieved medical data to the care providing site server.

The managing may include identifying a disease category corresponding to symptom information on the user when the symptom information is received from the care providing site server, retrieving medical data with the identified disease category set, and providing the retrieved medical data to the care providing site server.

The managing may include determining a count of care providing site visits by the user based on a count of the medical data when a request for a count of care providing site visits by the user is received from an insurance company server or an institution server, and transmitting the count of care providing site visits by the user to the insurance company server or the institution server.

The care providing site server may identify a care providing site visit by the user using identification information on the user visiting the care providing site, and may provide a medical data interface for creating medical data on the user whose care providing site visit is verified to a doctor examining the user to create medical data.

The method may further include receiving a satisfaction level in a care providing site visit by the user from a terminal of the user and adding the satisfaction level to the medical data.

The managing may include grouping the medical data by care providing site based on a care providing site code included in the medical data, and determining a care providing site to recommend to the user based on a result of comparing the satisfaction level included in the grouped medical data.

According to an aspect of the present invention, there is provided an apparatus for managing medical data, the apparatus including a medical data collection unit configured to collect medical data from a plurality of care providing site servers including a first care providing site server associated with a first care providing site and a second care providing site server associated with a second care providing site; a user identification unit configured to identify a user associated with the collected medical data; and a medical data management unit configured to manage the medical data based on the user's care providing site visit including a first visit to the first care providing site and a second visit to the second care providing site.

The medical data management unit may provide first medical data collected by the first care providing site server and second medical data collected by the second care providing site server to the first care providing site server in response to a request of the medical data received from the first care providing site server.

The medical data management unit may identify a disease category corresponding to symptom information of the user when the symptom information is received from the first care providing site server; and provide medical data retrieved according to the identified disease category to the care providing site server.

The medical data management unit may determine a count of the user's care providing site visits based on a count of the medical data in response to a request of the count of the user's care providing site visits received from an insurance company server or an institution server; and transmit the determined count of the user's care providing site visits to the insurance company server or the institution server.

The care providing site server may identify the user's care providing site visit using identification information of the user visiting the first care providing site and provides a medical data interface for creating or updating the medical data of the user to a doctor examining the user.

### Effect

According to embodiments of the present invention, it is possible to easily determine a count of care providing site visits by a user creating new medical data whenever the user visits a care providing site.

Also, according to embodiments of the present invention, it is possible to easily determine a count of care providing site visits by a user by managing medical data based on care providing site visits by the user.

In addition, according to embodiments of the present invention, it is possible to unify and manage medical data created when the user visits different care providing sites, and to provide a care providing site that the user visits with medical data created by the care providing site and other care providing sites, thereby allowing sharing of the medical data of the user created by the different care providing sites.

Furthermore, according to embodiments of the present invention, when care providing sites use different formats of medical data, care providing site medical data created by each care providing site server may be converted into a unified medical data format in accordance with a standard format such that contents of medical data written in a different format by another care providing site may be easily understood by all other care providing sites.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a medical data management system according to an embodiment of the present invention;

FIG. 2 illustrates a care providing site server according to an embodiment of the present invention;

FIG. 3 illustrates a medical data management apparatus according to an embodiment of the present invention;

FIG. 4 illustrates a medical data management apparatus according to another embodiment of the present invention;

FIG. 5 illustrates a medical data unifying process according to an embodiment of the present invention;

FIG. 6 illustrates a medical data management apparatus according to an embodiment of the present invention;

FIG. 7 illustrates a medical data management method according to an embodiment of the present invention;

FIG. 8 illustrates an example of a medical data management process by care providing site visit of FIG. 7 according to an embodiment of the present invention;

FIG. 9 illustrates another example of a medical data management process by care providing site visit described in FIG. 7 according to an embodiment of the present invention;

FIG. 10 illustrates still another example of a medical data management process by care providing site visit described in FIG. 7 according to an embodiment of the present invention;

FIG. 11 is a flowchart illustrating a care providing site visit checking method according to an embodiment of the present invention;

FIG. 12 is a flowchart illustrating an example of a medical data management method according to an embodiment of the present invention; and

FIG. 13 is a flowchart illustrating another example of a medical data management method according to an embodiment of the present invention.

### DETAILED DESCRIPTION

Hereinafter, exemplary embodiments of the present invention will be described in detail with reference to the accompanying drawings. A medical data management method according to an embodiment of the present invention may be carried out by a medical server and a medical data management apparatus included in a medical data management system.

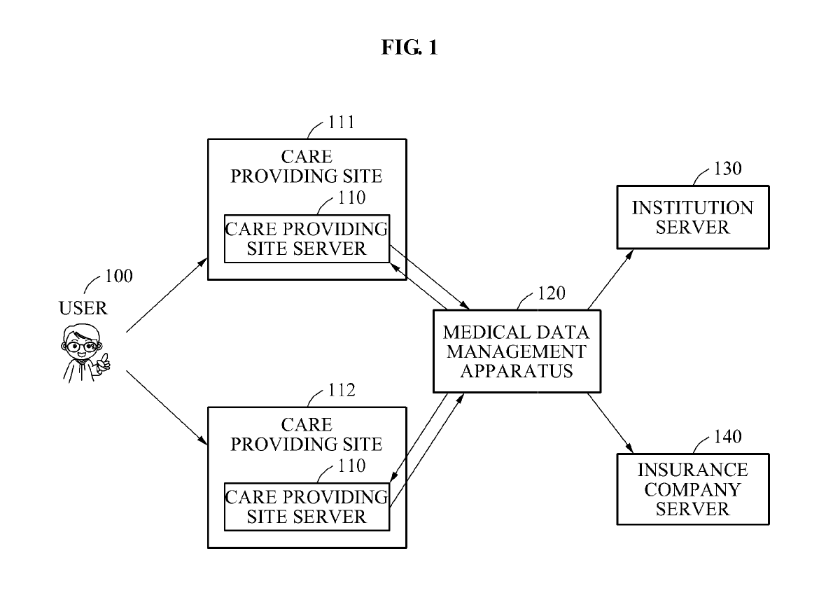

FIG. 1 illustrates a medical data management system according to an embodiment of the present invention. Referring to FIG. 1, the medical data management system may include a care providing site server 110 associated with each care providing site and a medical data management apparatus 120. The care providing site server 110 may be physically installed at a care providing site or located remotely.

When a user 100 goes to a care providing site 111, a care providing site server 110 associated with the care providing site 111 may check a visit to the care providing site 111 by the user 100 and create medical data of the user 100. For example, the medical data may include at least one of admission notes, discharge notes, transfer notes, doctor's diagnoses, prescriptions, nurse's notes and examination notes for the user. The care providing site 111 may be one of health care institutions, such as a general care providing site, a clinic and a community health center.

When the user 100 visits another care providing site 112, a care providing site server 110 associated with the other care providing site 112 may check a visit to the care providing site 112 by the user 100 and create medical data of the user 100. Here, the medical data of the user 100 created by the care providing site server 110 of the care providing site 112 may have a format that is the same as or different from a format of the medical data of the user 100 created by the care providing site server 110 of the care providing site 111.

For example, the care providing site server 110 may include an electronic medical record (EMR) associated with the care providing site 111. Here, the EMR may create and manage medical data by care providing site. Further, the EMR may create medical data, such as Continuity of Care Document (CCD), in accordance with Health Level Seven International (HL7), for example. Also, the EMR may further create a Discharge Summary (D/S) of a history of a discharged user.

Here, the medical data management apparatus 120 may collect and manage the medical data of the user 100 from each of the care providing site server 110 of the care providing site 111 and the care providing site server 110 of the care providing site 112. When the user 100 revisits the care providing site 111 or the care providing site 112 or visits another care providing site, the medical data management apparatus 120 may provide the medical data of the user 100 created by the care providing site server 110 of the care providing site 111 and the medical data on the user 100 created by the care providing site server 110 of the care providing site 112 in response to a request received from a server of a care providing site visited by the user.

That is, the medical data management apparatus 120 may collect medical data created by different care providing site servers with regard to the user's visits. The medical data management apparatus 120 may provide the collected medical data to a care providing site server of a care providing site that the user visits, thereby providing the user or a doctor who examines the user with user record information from the care providing site that the user visits and user record information from another care providing site.

National healthcare organizations or health insurance companies may need a count of care providing site visits by the user 100 to determine medical insurance fees. Here, an institution server 130 of a national institution or an insurance company server 140 of a health insurance company may request the count of care providing site visits by the user 100 from the medical data management apparatus 120.

The medical data management apparatus 120 may determine a count of care providing site visits by the user 100 based on the medical data of the user 100 collected from the care providing site servers 110 and may transmit the count of care providing site visits to the institution server 130 or the insurance company server 140. Here, the care providing site servers 110 may create new or updated medical data of the user 100 whenever the user 100 visits the care providing sites.

The medical data management apparatus 120 may manage the medical data of the user 100 based on care providing site visit by the user, and thus, a medical data count for the user 100 managed by the medical data management apparatus 120 may be a count of care providing site visits by the user 100. Thus, the medical data management apparatus 120 may determine a count of care providing site visits by the user 100 based on the medical data count for the user 100.

The medical data of the user 100 created by the care providing site server 110 of the care providing site 112 may have a different format from a format of the medical data of the user 100 created by the care providing site server 110 of the care providing site 111. In this case, regarding the same disease of the user 100, it may be difficult to compare medical data entered by the care providing site sever 110 of the care providing site 111 with medical data entered by the care providing site server 110 of the care providing site 112 due to the different formats. Thus, when the care providing site servers 110 create medical data in different formats, the formats of the medical data created by the care providing site serves 110 may need to be unified.

Here, the medical data management apparatus 120 may convert the medical data created by the different care providing site servers 110 into unified medical data having the same format in accordance with a standard format collectively applied to all medical data. The medical data management apparatus 120 may manage the unified medical data based on care providing site visits by a user.

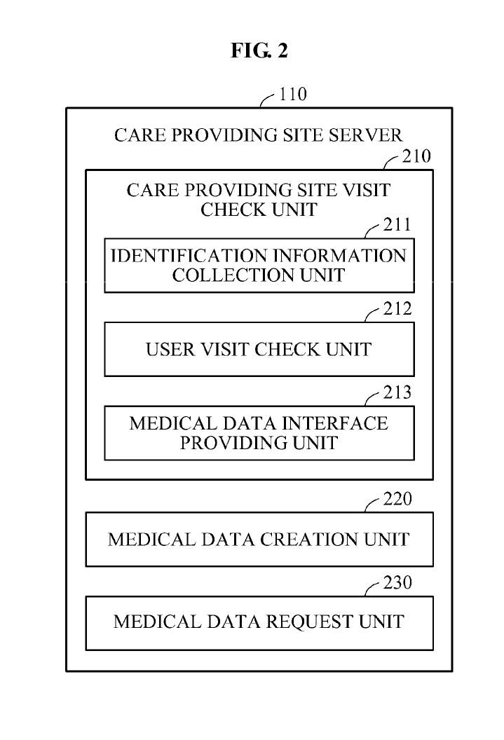

FIG. 2 illustrates a care providing site server according to an embodiment of the present invention. Referring to FIG. 2, the care providing site server 110 associated with a care providing site may include a care providing site visit check unit 210, a medical data creation unit 220 and a medical data request unit 230.

The care providing site visit check unit 210 may check a user's visit to a care providing site and provide a medical data interface for creating medical data of the user to a doctor who examines the user. Here, as shown in FIG. 2, the care providing site visit check unit 210 may include an identification information collection unit 211, a user visit check unit 212 and a medical data interface providing unit 213.

The identification information collection unit 211 may collect identification information on a user visiting the care providing site. For example, the identification information of the user may include at least one of personal information of the user, image information of the user and biometric information of the user. Here, the personal information of the user may include at least one of a name, identification (ID), gender, birth date, email address, and a unique number such as a social security number, resident registration number, driver's license number and Medicaid number. The image information of the user may be an image including the user's face. The biometric information of the user may include at least one of a fingerprint, a palm print, iris information and vein information.

Here, the identification information collection unit 211 may be connected to a sensor which measures biometric information of a user. The identification information collection unit 211 may collect biometric information of a user measured by the sensor as identification information of the user. For instance, the sensor may include at least one of a fingerprint recognition sensor, a palm recognition sensor and a face recognition sensor.

Also, the identification information collection unit 211 may be connected to a reader capable of reading a smart card that a user possesses. When the reader reads identification information of the user included in the smart card of the user, the identification information collection unit 211 may collect the identification information of the user read by the reader. The user visit check unit 212 may check a user's visit to the care providing site using identification information collected by the identification information collection unit 211. For example, when the identification information collection unit 211 collects a fingerprint of a user via the sensor, the user visit check unit 212 may retrieve the user corresponding to the collected fingerprint from a database of fingerprints of users and determine that the retrieved user visits the care providing site.

Also, when the identification information collection unit 211 recognizes a face of a user via the sensor, the user visit check unit 212 may retrieve the user corresponding to the recognized face from a database of facial images of users and determine that the retrieved user visits the care providing site.

When the identification information collection unit 211 collects user identification information of a user included in a smart card of the user, the user visit check unit 212 may retrieve the user corresponding to the collected identification information from a database of identification information of users and determine that the retrieved user visits the care providing site.

Here, the user visit check unit 212 may store user encounter data. For instance, the user visit check unit 212 may encounter data on a user in an EMR based on identification information of the user whose visit to the care providing site is verified. Further, the user visit check unit 212 may transmit the identification information of the user whose visit to the care providing site is verified to the medical data management apparatus 120.

The care providing site server 110 may further include a visit system which manages encounter data on a user in association with identification information of the user, separately from the EMR. Here, the user visit check unit 212 may store the encounter data of the user in the visit system based on the identification information of the user whose visit to the care providing site is verified.

The medical data interface providing unit 213 may provide a doctor examining the user with the medical data interface for creating the medical data of the user whose visit to the care providing site is verified by the user visit check unit 212. For example, the medical data interface may include an input interface for inputting at least one of user symptom information, user examination information, user diagnosis information and user prescription information.

The medical data creation unit 220 may create medical data based on data input via the medical data interface, user identification information, user visit time information and identification information of the care providing site that the user visits, which are provided by the care providing site visit check unit 210 to the doctor. Here, the medical data may include at least an EMR or D/S. The input data may include at least one of user symptom information, user examination information, user diagnosis information and user prescription information.

For example, when the user visits the care providing site 111, when the user is admitted to or discharged from the care providing site, or when the user is transferred from one care providing site to another care providing site, care providing site admission information about admission, discharge or transfer may be created. Further, when a health care provider, such as a doctor, diagnoses a symptom of the user and prescribes for the diagnosed symptom, diagnosis data and prescription data may be created. When a nurse writes a record or examination is involved with equipment, nurse notes or examination notes may be created.

Here, the medical data creation unit 220 may create medical data by matching the user identification information with the created information. The medical data creation unit 220 may store the created medical data in the EMR based on the user identification information.

The medical data creation unit 220 may match the medical data with a care providing site code for identifying the care providing site with which the care providing site server 110 is associated. When the same user visits the care providing site having the care providing site server 110 a plurality of times, the medical data creation unit 220 may create new or updated medical data for each user visit.

The medical data creation unit 220 may be provided as the same configuration as the EMR or as a configuration that is different from the EMR. When the medical data creation unit 220 is a separate configuration from the EMR, the EMR may store and manage the medical data created by the medical data creation unit 220.

The medical data creation unit 220 may be provided as a separate configuration from the care providing site server 110. For example, the medical data creation unit 220 may be installed in a gateway which relays the care providing site server 110 and the medical data management apparatus 120. Here, the care providing site visit check unit 210 may transmit the data input via the medical data interface, the user identification information, the user visit time information and the identification information of the care providing site that the user visits, which are provided to the doctor, to the medical data management apparatus 120. The data and information transmitted to the medical data management apparatus 120 may pass through the gateway. Here, the medical data creation unit 220 installed in the gateway may create medical data based on the received data and information and transmit the medical data to the medical data management apparatus 120.

The medical data request unit 230 may request the medical data of the user whose visit to the care providing site is verified from the medical data management apparatus 120 when the care providing site visit check unit 210 provides the medical data interface to the doctor. The medical data request unit 230 may provide the doctor or user with the medical data of the user received from the medical data management apparatus 120 in response to the doctor's or user's request. Here, the medical data of the user received by the medical data request unit 230 may include user record information received from different care providing sites.

When symptom information is input via the medical data interface provided by the care providing site visit check unit 210 to the doctor, the medical data request unit 230 may transmit the symptom information to the medical data management apparatus 120 and request medical data related to the symptom information. The medical data request unit 230 may receive the medical data related to the symptom information from the medical data management apparatus 120 in response to the request. Next, the medical data request unit 230 may provide the medical data related to the symptom information to the doctor or user. Here, the medical data related to the symptom information may be medical data with a disease category set corresponding to the symptom information among medical data of the user or other users.

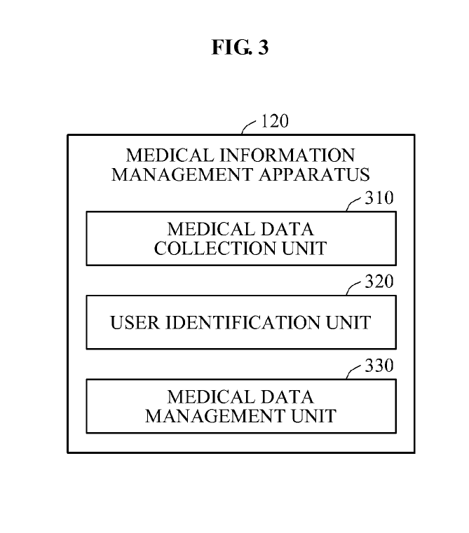

FIG. 3 illustrates a medical data management apparatus according to an embodiment of the present invention. Referring to FIG. 3, the medical data management apparatus 120 may include a medical data collection unit 310, a user identification unit 320 and a medical data management unit 330.

The medical data collection unit 310 may collect medical data in a cloud manner from a care providing site server 110 associated with at least one care providing site. Here, the medical data collection unit 310 may retrieve medical data from the care providing site server 110 at regular intervals and collect medical data created since the previous retrieval time up to the current retrieval time. Also, the care providing site server 110 creating medical data based on a user visit may transmit the created medical data in real time to the medical data management apparatus 120. Here, the medical data collection unit 310 may collect the medical data transmitted by the care providing site server 110.

The user identification unit 320 may identify a user included in the medical data collected by the medical data collection unit 310. Here, the medical data may include identification information collected by the care providing site server 110 to verify a user visit.

The user identification unit 320 may extract the identification information included in the medical data to identify the user corresponding to the medical data. Here, the identification information of the user may include at least one of biometric information of the user, a name of the user, a resident registration number of the user and an ID of the user.

When care providing site servers 110 associated with different care providing sites create medical data in the same standard format, the user identification unit 320 may retrieve at least one of an item, a bit and a location including user identification information in the standard format to identify a user. The user identification unit 320 may identify an address at which user identification information is stored in the medical data based on a care providing site code matching the medical data, or a user identification information type included in the medical data. The user identification unit 320 may extract the information stored at the identified address or the identified information type as user identification information to identify a user.

The user identification unit 320 may convert the care providing site code matching the medical data using a user identification code corresponding to the identified user. For example, when the care providing site code is code 11, the user identification unit 320 may convert code 11 into code 11z4 by adding user identification code z4 at the end of the care providing site code. Alternatively, the user identification unit 320 may convert code 11 to code z411 by adding user identification code z4 in front of the care providing site code, or to code 1z41 by adding user identification code z4 in the middle of the care providing site code.

When the medical data includes information representing the care providing site having the care providing site server 110, the user identification unit 320 may change the care providing site code to a user identification code. For example, when the care providing site code is code 11, the user identification unit 320 may change the care providing site code 11 with the user identification code z4 to code z4.

The medical data management unit 330 may manage medical data of a user based on a care providing site visit by the user identified by the user identification unit 320 visiting the care providing site. Here, the medical data management unit 330 may store and manage medical data in each of a plurality of databases constructed on the cloud.

Further, the medical data management unit 330 may classify each of medical data collected by the medical data collection unit 310 into separate files or items to store and manage the medical data. Here, the medical data collected by the medical data collection unit 310 may be information created whenever the user visits a care providing site. Thus, a count of medical data collected by the medical data collection unit 310 may be a count of care providing site visits by the user.

For example, the medical data management unit 330 may receive a request for a count of care providing site visits by the user from an insurance company server or institution server. Here, the medical data management unit 330 may determine a count of care providing site visits by the user based on a number of medical data of the user stored for each care providing site visit. The medical data management unit 330 may transmit the determined count of care providing site visits by the user to the insurance company server or institution server.

The medical data management unit 330 may group the plurality of medical data of the user based on the user identification code included in the care providing site code changed by the user identification unit 320 or the user identification code changed from the care providing site code. Further, the medical data management unit 330 may group pieces of medical data having the same user identification code as medical data of the user.

For example, the care providing site server 110 may request medical data. Here, the medical data management unit 330 may retrieve medical data collected by the care providing site server 110 and medical data collected by a care providing site server of a different care providing site from the care providing site having the care providing site server 110 among the grouped medical data as the medical data of the user. The medical data management unit 330 may provide the retrieved medical data to the care providing site server 110 requesting the medical data.

The medical data collection unit 310 may group the medical data into at least one group based on the items and contents included in the medical data or set a category for the medical data. Here, the medical data collection unit 310 may define a disease category based on a name of a disease. The medical data collection unit 310 may set a disease category of the medical data based on symptom information, diagnosis information and prescription information included in the medical data.

For example, the medical data management unit 330 may receive symptom information of the user from the care providing site server 110. Here, the medical data management unit 330 may identify a disease category corresponding to the received symptom information. Further, the medical data management unit 330 may calculate a similarity between symptom information set in the disease category and the received symptom information. The medical data management unit 330 may identify a disease category having a threshold value that is similar to or higher than a value of the disease category corresponding to the symptom information. For example, when the symptom information is a high fever, the medical data management unit 330 may identify all diseases involving increase in body temperature of the user as the disease category corresponding to the symptom information.

The medical data management unit 330 may retrieve medical data with the identified disease category set. Next, the medical data management unit 330 may provide the retrieved medical data to the care providing site server 110 transmitting the symptom information of the user. Here, the care providing site server 110 may classify medical data by disease category and provide the medical data to the doctor. That is, the medical data management unit 330 may provide medical data of a plurality of diseases having similar symptoms to the doctor, helping the doctor to make accurate diagnosis for the user by comparing various cases.

Further, the medical data management unit 330 may receive encounter data of the user from the care providing site server 110 or a visit system. Here, the medical data management unit 30 may match the received encounter data of the user to the medical data of the user to store and manage the encounter data. For example, the medical data and the encounter data may be encoded based on the user identification code. Here, the medical data management unit 330 may match the encounter data with the medical data based on the user identification code. The medical data management unit 330 may store the encounter data and the medical data matched to the encounter data in the same physical or logical database.

The medical data management unit 330 may store and manage the encounter data and the medical data without any link. Here, the medical data management unit 330 may store the encounter data and the medical data of the user in physically or logically different databases.

In addition, the care providing site server 110 or medical data management unit 330 may receive a satisfaction level with respect to a care providing site visit from a user terminal. The care providing site server 110 or the medical data management unit 330 may add the satisfaction level received from the user terminal to the medical data.

Here, the medical data management unit 330 may group medical data by care providing site based on a care providing site code included in the medical data. The medical data management unit 330 may determine a care providing site to recommend to the user based on a result of comparing satisfaction levels included in the grouped medical data.

Finally, the medical data management unit 330 may provide a name and a location of the determined care providing site to the user terminal when the user requests a recommended care providing site. Here, the medical data management unit 330 may receive a care providing site type which the user wants to visit from the user terminal. The medical data management unit 330 may retrieve and provide a care providing site corresponding to the received care providing site type selected from determined care providing sites to the user terminal Here, the care providing site type may be classified based on a body part to be examined, for example, an internal medicine clinic, a surgical clinic or the like, or based on a care providing site size, for example a clinic, a general care providing site or the like.

For example, the medical data management apparatus may include a transmitter/receiver, processor and memory connected to each other. The transmitter/receiver may be the medical data collection unit 310 to collect medical data from at least of a care provider site server. The memory may be non-transitory computer-readable medium. The memory may have stored thereon a program that, when executed, causes the processor to perform a method. The method may include verifying the user and the user's visit to the care service providing site based on the collected identification information, and providing a medical data interface for creating medical data o the verified user to a doctor that medically assesses the user.

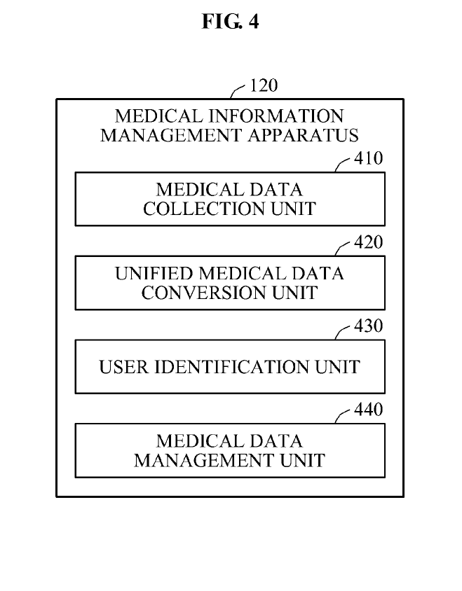

FIG. 4 illustrates a medical data management apparatus according to another embodiment of the present invention. In particular, the medical data management apparatus illustrated in FIG. 4 manages medical data when care providing site servers 110 associated with different care providing sites create different formats of medical data. Referring to FIG. 4, the medical data management apparatus 120 may include a medical data collection unit 410, a unified medical data conversion unit 420, a user identification unit 430 and a medical data management unit 440.

The medical data collection unit 410 may collect care providing site medical data created in unique formats from care providing site servers associated with various care providing sites. Here, the medical data collection unit 410 may retrieve data from the care providing site servers 110 at regular intervals and collect care providing site medical data since the previous retrieval time up to the current retrieval time. Also, the care providing site servers 110, which create care providing site medical data based on a user visit, may transmit the created care providing site medical data in real time to the medical data management apparatus 120. Here, the medical data collection unit 410 may collect the care providing site medical data transmitted by the care providing site servers 110.

The unified medical data conversion unit 420 may convert care providing site medical data into unified medical data formatted in accordance with a standard format based on a care providing site code of a care providing site. The care providing site medical data collected by the medical data collection unit 410 may include various names, numbers and types of items per care providing site server 110. For example, care providing site medical data of a first care providing site server may include a name of a disease diagnosed by a doctor as an item of disease name, and care providing site medical data of a second care providing site server may include the name of the disease as an item of diagnosis result.

That is, as “disease name” and “diagnosis result” are items of the care providing site medical data having the same meaning but are specified by different names by different care providing sites, the medical data management unit 440 may possibly determine these items to be different. Thus, the unified medical data conversion unit 420 may unify such items as common care providing site medical data.

Here, the unified medical data conversion unit 420 may identify an item included in the care providing site medical data based on a care providing site code. Next, the unified medical data conversion unit 420 may retrieve an item having a close similarity to the identified item among items included in the standard format. Finally, the unified medical data conversion unit 420 may convert a name of the identified item or identified information into a name of the retrieved item or retrieved identification information.

For example, a name of a disease diagnosed by a doctor may be defined as “name of disease” in the standard format. Here, the unified medical data conversion unit 420 may determine that “disease name” among items of the care providing site medical data of the first care providing site server has the closest similarity to “name of disease” and convert “disease name” into “name of disease.” Further, the unified medical data conversion unit 420 may determine that “diagnosis result” among items of the care providing site medical data of the second care providing site server has the closest similarity to “name of disease” and convert “diagnosis result” into “name of disease.”

That is, the unified medical data conversion unit 420 may convert “disease name” of the care providing site medical data of the first care providing site server and “diagnosis result” of the care providing site medical data of the second care providing site server, which have the same meaning, into the same name “name of disease” so that the medical data management unit 440 may treat the corresponding items as the same item.

Here, the unified medical data or items included in the care providing site medical data may include at least one of user visit time information, user identification information, user symptom information, user diagnosis information, user prescription information and user examination information.

Further, as for the care providing site medical data collected by the medical data collection unit 410, the same data may be stored with different data codes depending on the care providing site servers 110. For example, the care providing site medical data of the first care providing site server may store a “cold” with a Korean code of “cold” as the name of the disease, and the care providing site medical data of the second care providing site server may store a cold with a symbol code corresponding to a cold.

As for a symbol code stored in the care providing site medical data, the same data may be stored with different symbols depending on the care providing site servers 110. For example, the care providing site medical data of the second care providing site server may store a cold with a symbol code of “3HHDOD,” and care providing site medical data of a third care providing site server may store a cold with a symbol code of “WGQF” and store an ache as a symbol code of “3HHDOD.”

That is, while the second care providing site server stores a cold with the symbol code of “3HHDOD” in the care providing site medical data, the medical data management unit 440 interprets the symbol code of “3HHDOD” as the symbol code of the third care providing site server, i.e., an ache. Also, the medical data management unit 440 may not possibly recognize that “cold” and “3HHDOD” are the same.

Thus, the unified medical data conversion unit 420 may unify various data codes specifying a same item of the care providing site medical data. Here, the unified medical data conversion unit 420 may identify a data code of an item included in care providing site medical data based on a care providing site code. Next, the unified medical data conversion unit 420 may retrieve a data code corresponding to the identified data code among data codes defined in the standard format. Finally, the unified medical data conversion unit 420 may convert the identified data code into the data code defined in the standard format.

For example, a data code of a cold may be defined as a Korean code of “cold” in the standard format. Here, since “cold” included in the care providing site medical data of the first care providing site server is the same as that in the standard format, no conversion needs to be performed by the unified medical data conversion unit 420.

The unified medical data conversion unit 420 may identify a symbol code of “3HHDOD” included in the care providing site medical data of the second care providing site server as a cold based on a care providing site code of the second care providing site server. Here, the unified medical data conversion unit 420 may retrieve a data code “cold” in the standard format corresponding to the symbol code “3HHDOD” included in the care providing site medical data of the second care providing site server. The unified medical data conversion unit 420 may convert the symbol code “3HHDOD” included in the care providing site medical data of the second care providing site server into “cold.”

That is, the unified medical data conversion unit 420 may convert “cold” of the care providing site medical data of the first care providing site server and the data code “3HHDOD” of the care providing site medical data of the second care providing site server, which have the same meaning, into “cold” as the code defined in the standard format so that the medical data management unit 440 may regard the data as the same information. Here, the data code may be at least one of Korean data, English data and symbol data for identifying at least one of a user's symptom, a doctor's diagnosis for the user, a doctor's prescription for the user and a user's examination result.

The user identification unit 430 may identify a user included in the unified medical data converted by the unified medical data conversion unit 420. Here, the medical data may include identification information collected by the care providing site servers 110 to verify a user visit.

The user identification unit 430 may extract the identification information included in the medical data to identify a user corresponding to the medical data. For example, since the unified medical data is converted in accordance with the standard format, an item including the user identification information, a bit and a location of the identification information may be fixed in the standard format. Thus, the user identification unit 430 may identify the user by retrieving at least one of the item including the user identification information, the bit and the location of the identification information from the standard format.

The user identification unit 430 may convert a care providing site code matching the unified medical data using a user identification code corresponding to the identified user. When the unified medical data includes information representing a care providing site having the care providing site server 110, the user identification unit 430 may convert the care providing site code into a user identification code.

The medical data management unit 440 may manage unified medical data of a user by care providing site visit by the user identified by the user identification unit 430. In detail, the medical data management unit 440 may classify each of unified medical data converted by the unified medical data conversion unit 420 into separate files or items to store and manage the unified medical data. Here, the care providing site medical data collected by the medical data collection unit 410 may be information created whenever the user visits a care providing site. Thus, a count of unified medical data converted from the care providing site medical data may be a count of care providing site visits by the user.

For example, the medical data management unit 440 may receive a request for the count of care providing site visits by the user from an insurance company server or institution server. Here, the medical data management unit 440 may determine a count of care providing site visits by the user based on a number of unified medical data of the user stored per care providing site visit. The medical data management unit 440 may transmit the determined count of care providing site visits by the user to the insurance company server or institution server.

The medical data management unit 440 may group a plurality of unified medical data of the user based on the user identification code included in the care providing site code changed by the user identification unit 430 or the user identification code changed from the care providing site code. Further, the medical data management unit 440 may group a plurality of unified medical data having the same user identification code as unified medical data of the user.

For example, a care providing site server 110 may request medical data. In response to the request, the medical data management unit 440 may retrieve not only medical data collected by the care providing site server 110 requesting the medical data, but also medical data collected by a different care providing site server of a different care providing site. The medical data management unit 440 may provide the retrieved medical data to the care providing site server 110 requesting the medical data. Here, since the retrieved medical data is unified medical data converted in accordance with the standard format, the unified medical data conversion unit 430 may convert the retrieved medical data into care providing site medical data corresponding to the care providing site server 110 requesting the medical data. The medical data management unit 440 may transmit the medical data, converted into the care providing site medical data, to the care providing site server 110.

In detail, the unified medical data conversion unit 420 may identify a format used by the care providing site server 110 requesting the medical data based on the care providing site code of the care providing site server 110 requesting the medical data. Next, the unified medical data conversion unit 420 may convert the retrieved medical data in accordance with the identified format of the care providing site server.

The medical data collection unit 410 may group the unified medical data into at least one group based on items and contents included in the unified medical data or set a category for the unified medical data. Here, the medical data collection unit 410 may define a disease category based on a disease name. The medical data collection unit 410 may set a disease category of the unified medical data based on symptom information, diagnosis information and prescription information included in the unified medical data.

For example, the medical data management unit 440 may receive symptom information of the user from the care providing site server 110. Here, the medical data management unit 440 may identify a disease category corresponding to the received symptom information. Further, the medical data management unit 440 may calculate a similarity between symptom information set in the disease category and the received symptom information. The medical data management unit 440 may identify a disease category having a threshold value that is similar to or higher than a value of the disease category corresponding to the symptom information. For example, when the symptom information is a high fever, the medical data management unit 440 may identify all diseases involving increase in body temperature of the user as the disease category corresponding to the symptom information.

The medical data management unit 440 may retrieve unified medical data with the identified disease category set. Next, the medical data management unit 440 may provide the retrieved unified medical data to the care providing site server 110 transmitting the symptom information of the user. Here, the care providing site server 110 may classify unified medical data by disease category and provide the unified medical data to the doctor.

The care providing site server 110 or medical data management unit 440 may receive a satisfaction level with regard to a user's care providing site visit from a user terminal. The care providing site server 110 may add the satisfaction level received from the user terminal to the care providing site medical data, or the medical data management unit 440 may add the satisfaction level to the unified medical data.

Here, the medical data management unit 440 may group unified medical data by care providing site based on a care providing site code included in the medical data. The medical data management unit 440 may determine a care providing site to recommend to the user based on satisfaction levels included in the grouped unified medical data.

Finally, the medical data management unit 440 may provide a name and a location of the determined care providing site to the user terminal when the user requests a recommended care providing site. Here, the medical data management unit 440 may receive a care providing site type which the user wants to visit from the user terminal. The medical data management unit 440 may retrieve and provide a care providing site corresponding to the received care providing site type selected from determined care providing sites to the user terminal Here, the care providing site type may be classified based on a body part to be examined, for example, an internal medicine clinic, a surgical clinic or the like, or based on a care providing site size, for example a clinic, a general care providing site or the like.

For example, the medical data management apparatus may include a transmitter/receiver, processor and memory connected to each other. The transmitter/receiver may be the medical data collection unit 410 to collect medical data from at least of a care provider site server. The memory may be non-transitory computer-readable medium. The memory may have stored thereon a program that, when executed, causes the processor to perform a method. The method may include verifying the user and the user's visit to the care service providing site based on the collected identification information, and providing a medical data interface for creating medical data o the verified user to a doctor that medically assesses the user.

For example, the medical data management apparatus may include a transmitter/receiver, processor and memory connected to each other. The transmitter/receiver may be the medical data collection unit 410 to collect medical data from at least of a care provider site server. The memory may be non-transitory computer-readable medium. The memory may have stored thereon a program that, when executed, causes the processor to perform a method. The method may include verifying the user and the user's visit to the care service providing site based on the collected identification information, and providing a medical data interface for creating medical data o the verified user to a doctor that medically assesses the user.

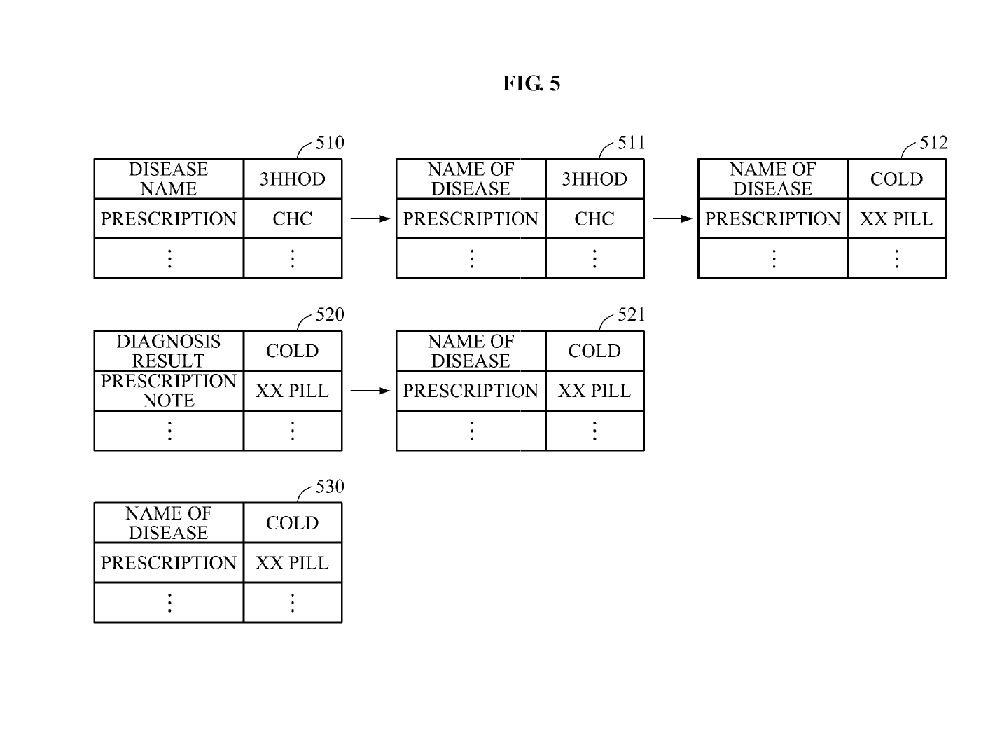

FIG. 5 illustrates a medical data unifying process according to an embodiment of the present invention. FIG. 5 shows a process of converting care providing site medical data 510 in accordance with a format of a first care providing site server and care providing site medical data 520 in accordance with a format of a second care providing site server into unified medical data of the same format according to the standard format of medical information 530.

The format of the first care providing site server may define a name of a disease diagnosed by a doctor as an item of “disease name” and prescription information by the doctor as an item of “prescription.” The format of the first care providing site server may store data codes of the items with symbol codes defined by the first care providing site server. Thus, the care providing site medical data 510 in accordance with the format of the first care providing site server may include the items of “disease name” and “prescription” and the symbol codes for the respective items, as shown in FIG. 5.

The format of the second care providing site server may define a name of a disease diagnosed by a doctor as an item of “diagnosis result” and prescription information by the doctor as an item of “prescription note.” The format of the second care providing site server may store data codes of the items with Korean codes. Thus, the care providing site medical data 520 in accordance with the format of the second care providing site server may include the items of “diagnosis result” and “prescription note” and the Korean codes for the respective items, as shown in FIG. 5.

The standard format may define a name of a disease diagnosed by a doctor as an item of “name of disease” and prescription information by the doctor as an item of “prescription.” Also, the standard format may store data codes of the items with Korean codes. Thus, the medical data 530 in accordance with the standard format may include the items of “name of disease” and “prescription” and the Korean codes for the respective items, as shown in FIG. 5.

The unified medical data conversion unit 420 may determine a similarity between the items of “disease name” and “prescription” included in the care providing site medical data 510 and the items of “name of disease” and “prescription” defined in the standard format. Here, since “disease name” has the closest similarity to “name of disease” and “prescription” is the same item, the unified medical data conversion unit 420 may convert “disease name” into “name of disease” as illustrated in care providing site medical data 511.

Next, the unified medical data conversion unit 420 may identify data codes of the standard format corresponding to the symbol codes stored by the first care providing site server based on a care providing site code. A data code of the standard format corresponding to “3HHOD” among the symbol codes stored by the first care providing site server may be a Korean code of “cold” and a data code of the standard format corresponding to “CHC” among the symbol codes stored by the first care providing site server may be a Korean code of “XX pill.” Thus, the unified medical data conversion unit 420 may convert the symbol code of “3HHOD” into the Korean code of “cold” and the symbol code of “CHC” into the Korean code of “XX pill,” thereby converting the care providing site medical data 511 into unified medical data 512.

Also, the unified medical data conversion unit 420 may determine a similarity between the items of “diagnosis result” and “prescription note” included in the care providing site medical data 520 and the items of “name of disease” and “prescription” defined in the standard format. Here, “diagnosis result” may have the closest similarity to “name of disease” and “prescription note” may have the closest similarity to “prescription.” The data codes included in the care providing site medical data 520 are the Korean codes corresponding to the standard format, and thus, the unified medical data conversion unit 420 may omit conversion of the data codes. Thus, the unified medical data conversion unit 420 may convert “diagnosis result” into “name of disease” and “prescription note” into “prescription,” thereby converting the care providing site medical data 520 into unified medical data 521 as illustrated in care providing site medical data 521.

The care providing site medical data 510 and the care providing site medical data 520 may display different information from the medical data 520 in accordance with the standard format, as shown in FIG. 5. However, the unified medical data 512 and the unified medical data 521 converted by the unified medical data conversion unit 420 in accordance with the standard format may display the same information as the medical data 530 in accordance with the standard format.

That is, the unified medical data conversion unit 420 may convert medical data including the same information but being displayed in different forms in accordance with the standard format to be displayed in the same form, as shown in FIG. 5. The Korean code of “cold” is the same as that in the standard format and thus may not be converted. The unified medical data conversion unit 420 may identify the symbol code of “3HHDOD” included in the care providing site medical data of the second care providing site server as a cold based on a care providing site code of the second care providing site server. Here, the unified medical data conversion unit 420 may retrieve a data code of “cold” in the standard format corresponding to the symbol code of “3HHDOD” included in the care providing site medical data of the second care providing site server. The unified medical data conversion unit 420 may convert the symbol code of “3HHDOD” included in the care providing site medical data of the second care providing site server into “cold.”

That is, the unified medical data conversion unit 420 may convert “cold” of the care providing site medical data of the first care providing site server and the data code “3HHDOD” of the care providing site medical data of the second care providing site server, which have the same meaning, into “cold” as the code defined in the standard format so that the medical data management unit 440 may regard the data as the same information.

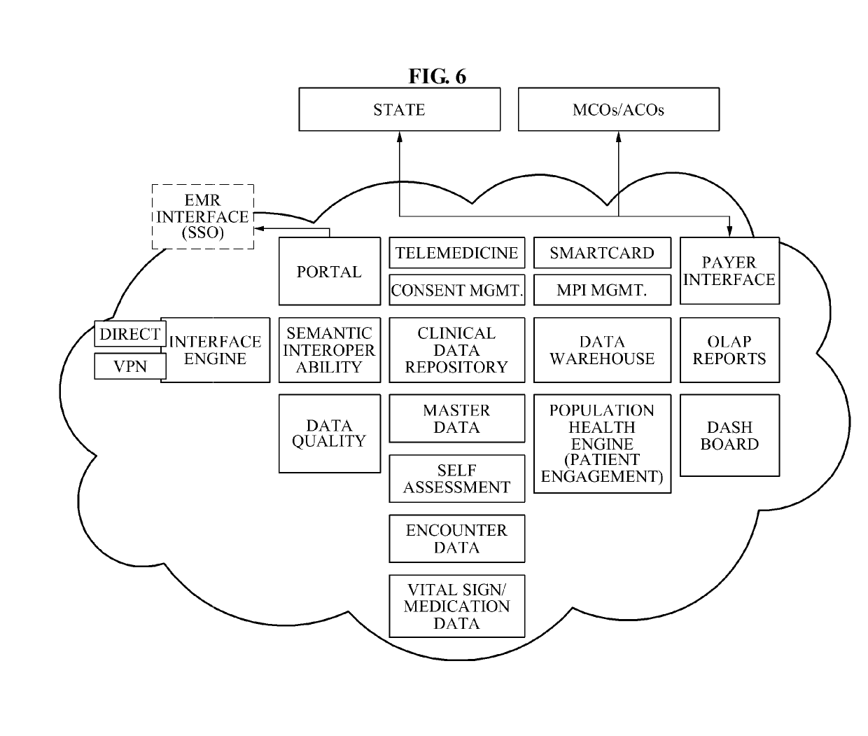

FIG. 6 illustrates a medical data management apparatus according to an embodiment of the present invention. The medical data management apparatus may include at least one of an interface engine, a semantic interoperability apparatus, a data quality apparatus, a clinical data repository, a consent management apparatus, a master data apparatus, and a master patient index management (MPI Mgmt) apparatus.

The interface engine may communicate with a care providing site server 110 to collect medical data and encounter data. Further, the medical data management apparatus may further include a portal accessing an EMR of the care providing site server 110 or an interface of an EMR configured separately from the care providing site server 110 to receive medical data. Here, the interface engine and the portal may be included in the medical data collection unit 410.

The semantic interoperability apparatus may analyze medical data created in different code systems of care providing sites. The semantic interoperability apparatus may convert medical data into standardized unified medical data based on an analysis result. The semantic interoperability apparatus and the data quality apparatus may be included in the unified medical data conversion unit 420.

The data quality apparatus may determine whether medical data collected from a plurality of care providing sites or clinical summary data of a user are inconsistent. When the medical data or the clinical summary data of the user are inconsistent, the data quality apparatus may automatically or manually cleanse the medical data or the clinical summary data of the user. Here, the data quality apparatus may cleanse the medical data or the clinical summary data of the user in real time or in batch mode.

Further, the data quality apparatus may define a rule set to identify inconsistency of the medical data collected from the plurality of care providing sites or the clinical summary data of the user. Here, the rule set may vary depending on automatic processing and manual processing.

The clinical data repository may manage summary history information on medical data on a user. The consent management apparatus may electrically receive and manage a consent to disclosure of user medical data. Here, the consent to the disclosure of the user medical data may be received from a user when a smart card used in a care providing site is issued for the user or when the user joins a site related to the medical data management apparatus. The consent management apparatus may determine a scope of medical data to be accessed by a care providing site or doctors based on a disclosure range of the consent to the disclosure of the user medical data.

The master data apparatus may collect master data as user identification information in association with a governmental institution server 130. Here, the clinical data repository, the consent management apparatus and the master data apparatus may be included in the medical data management unit 440.

The MPI management apparatus may identify a user using a Medicaid ID included in the master data collected by the master data apparatus. However, the Medicaid ID as identification information of the user may not be included in the medical data. Here, the MPI management apparatus may also identify a patient using demographic information, such as a name, gender, birth date, telephone number and address of the patient. Here, the MPI management apparatus may be included in the user identification unit 430.

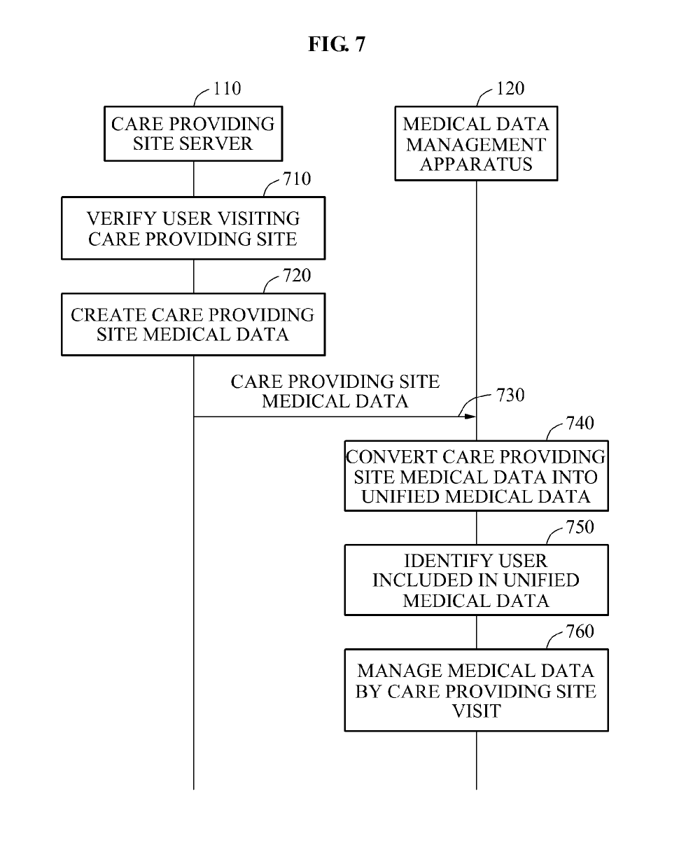

FIG. 7 illustrates a medical data management method according to an embodiment of the present invention. Referring to FIG. 7, in operation 710, the care providing site server 110 may verify a care providing site visit by a user. In detail, the care providing site visit check unit 210 of the care providing site server 110 may check a user's visit to a care providing site and provide a medical data interface for creating medical data on the user to a doctor who examines the user.

In operation 720, the care providing site server 110 may create care providing site medical data on the user verified in operation 710. In detail, the medical data creation unit 220 of the care providing site server 110 may create the care providing site medical data by applying input data input via the medical data interface provided to the doctor in operation 710, user identification information, user visit time information and identification information of the care providing site that the user visits to a specific format of the care providing site.

In operation 730, the medical data collection unit 410 may collect the care providing site medical data created in operation 720 from the care providing site server 110. Here, the medical data collection unit 410 may retrieve data from the care providing site server 110 at regular intervals and collect care providing site medical data created since the previous retrieval time up to the current retrieval time. Also, the care providing site server 110 may transmit the care providing site medical data created in operation 720 in real time to the medical data management apparatus 120. Here, the medical data collection unit 410 may collect the care providing site medical data transmitted by the care providing site server 110.

In operation 740, the unified medical data conversion unit 420 may convert the care providing site medical data collected in operation 730 into unified medical data in accordance with a standard format on the basis of a care providing site code of the care providing site.

In operation 750, the user identification unit 430 may identify a user included in the unified medical data converted in operation 740. Here, the user identification unit 430 may group unified medical data identified to have the same user as unified medical data on the identified user.

In operation 760, the medical data management unit 440 may manage the unified medical data on the user by care providing site visit of the user identified in operation 750. Further, the medical data management unit 440 may classify each of the unified medical data converted in operation 740 into separate files or items to store and manage the unified medical data.

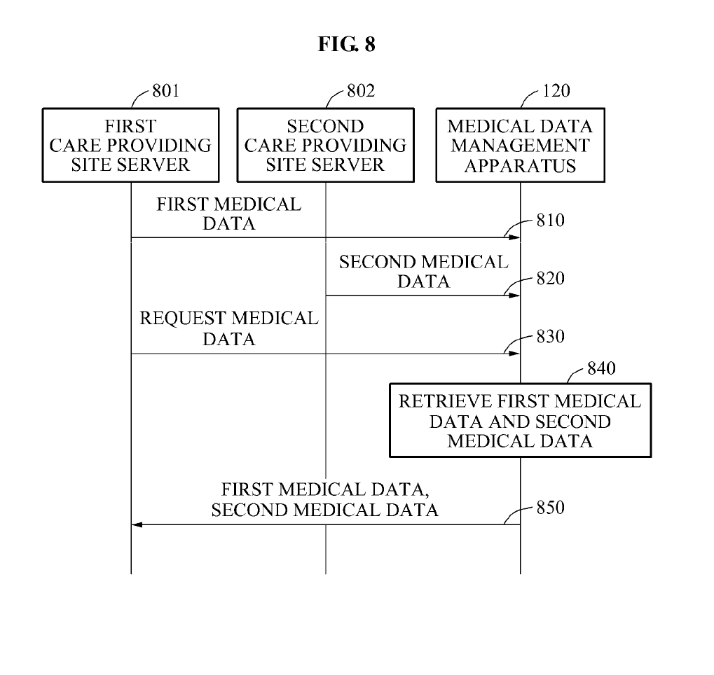

FIG. 8 illustrates an example of a medical data management process by care providing site visit described in FIG. 7 according to an embodiment of the present invention. FIG. 8 illustrates an embodiment of providing a doctor or user with medical data created by a care providing site that the user visits and medical data from another care providing site that the user visits in the medical data management process.

In operation 810, a first care providing site server 801 of a first care providing site visited by a user may create first medical data based on information input by a doctor examining the user. The medical data management apparatus 110 may collect the first medical data created by the first care providing site server 801.

In operation 820, a second care providing site server 802 of a second care providing site visited by the user may create second medical data based on information input by a doctor examining the user. The medical data management apparatus 110 may collect the second medical data created by the second care providing site server 802. Here, operations 810 and 820 may be performed at an interval between a first time when the user visits the first care providing site and a second time when the user visits the second care providing site. For example, when the user visits the first care providing site first and then visits the second care providing site three days later, operation 820 may be performed three days after operation 810 is performed.

In operation 830, the first care providing site server 801 of the first care providing site revisited by the user may check the user visit and request medical data on the user from the medical data management apparatus 120.

In operation 840, the medical data management apparatus 120 may retrieve the medical data of the user in response to the request received in operation 830. Here, the medical data management apparatus 120 may retrieve the first medical data collected in operation 810 and the second medical data collected in operation 820 as the medical data on the user.

In operation 850, the medical data management unit 330 may transmit the first medical data and the second medical data retrieved in operation 840 to the first care providing site server 801. Here, the first care providing site server 801 may provide the user or the doctor with the first medical data and the second medical data.

That is, the medical data management system may provide the doctor with not only the first medical data created by the first care providing site server 801, but also with the second medical data created by the second care providing site server 802 so that the doctor may diagnose and treat the user by referring to a diagnosis from another care providing site as well as a diagnosis by the doctor. In addition, the user may be provided with the first medical data created by the first care providing site server 801 and the second medical data created by the second care providing site server 802 to list care providing sites that the user visits for treatment of a disease and treatment results by the care providing sites.

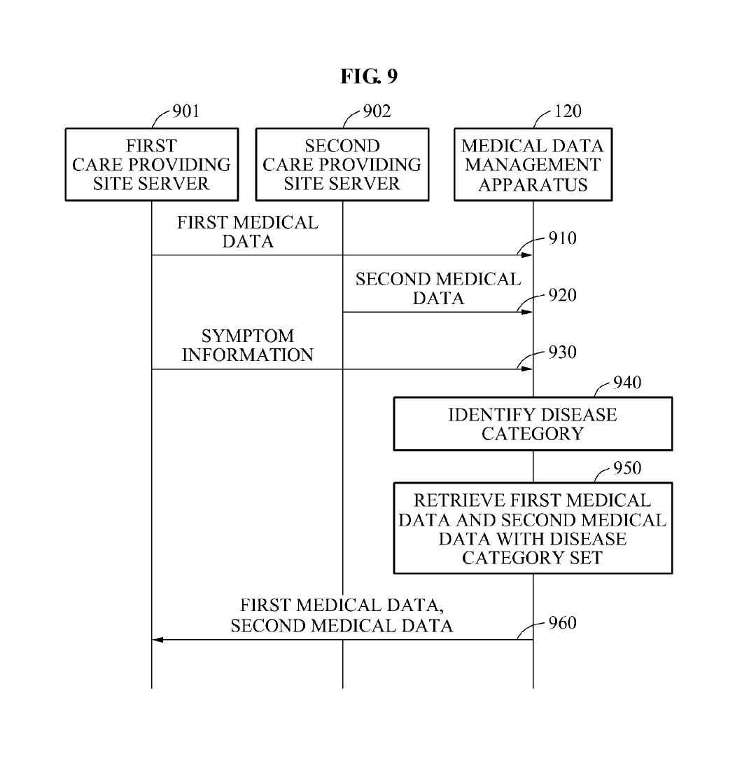

FIG. 9 illustrates another example of a medical data management process by care providing site visit described in FIG. 7 according to an embodiment of the present invention. FIG. 9 illustrates an embodiment of providing a doctor or user with medical data on another user having a similar symptom as the user or from another care providing site in the medical data management process.

In operation 910, a first care providing site server 901 of a first care providing site visited by a user may create first medical data based on information input by a doctor examining the user. The medical data management apparatus 110 may collect the first medical data created by the first care providing site server 901.

In operation 920, a second care providing site server 902 of a second care providing site visited by the user may create second medical data based on information input by a doctor examining the user. The medical data management apparatus 110 may collect the second medical data created by the second care providing site server 902. Here, the user visiting the first care providing site in operation 910 and the user visiting the second care providing site in operation 920 may be different users having similar symptoms or diseases or may be the same user.

In operation 930, the first care providing site server 901 of the first care providing site may receive an input of symptom information via a medical data interface provided to the doctor. Here, the first care providing site server 901 may transmit the symptom information to the medical data management apparatus 120 and request medical data related to the symptom information. Further, the user visiting the first care providing site in operation 930 may be a different user having a similar symptom or disease as the user visiting the first care providing site in operation 910 and the user visiting the second care providing site in operation 920 or may be the same user as the users visiting the first care providing site and the second care providing site.

In operation 940, the medical data management unit 330 may identify a disease category corresponding to the symptom information received in operation 930. Further, the medical data management unit 330 may calculate a similarity between symptom information set in the disease category and the received symptom information. The medical data management unit 330 may identify a disease category having a threshold value that is similar to or higher than a value of the disease category corresponding to the symptom information.

In operation 950, the medical data management unit 330 may retrieve medical data with the identified disease category set. Here, the user visiting the first care providing site in operation 930 has a similar symptom or disease as the user visiting the first care providing site in operation 910 and the user visiting the second care providing site in operation 920, and thus, the medical data management unit 330 may retrieve the first medical data and the second medical data.

In operation 960, the medical data management unit 330 may transmit the first medical data and the second medical data retrieved in operation 950 to the first care providing site server 901. Here, the first care providing site server 901 may provide the user or doctor with the first medical data and the second medical data. The first care providing site server 901 may classify the medical data by disease category and provide the medical data to the doctor.

That is, the medical data management system may provide medical data having similar symptoms as the user to the doctor, helping the doctor to make accurate diagnosis for the user by comparing various cases.

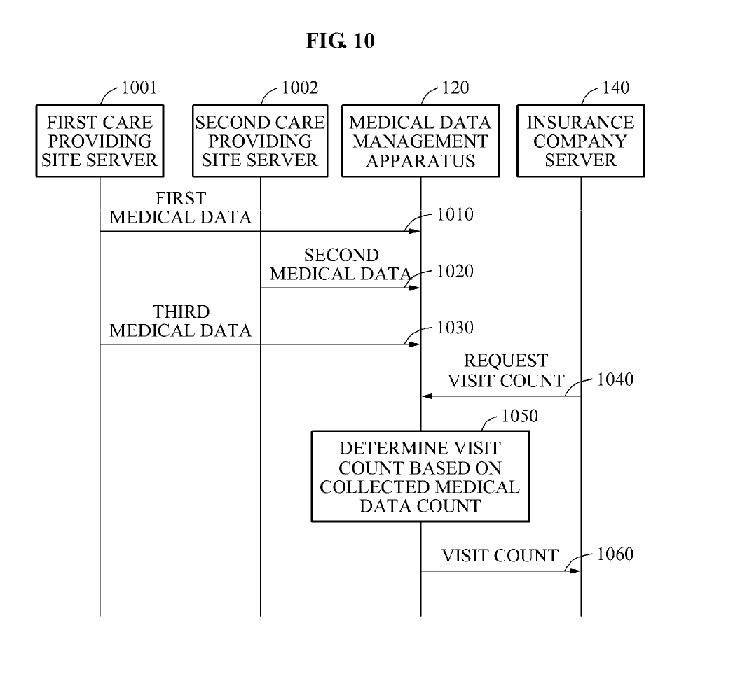

FIG. 10 illustrates still another example of a medical data management process by care providing site visit described in FIG. 7 according to an embodiment of the present invention. FIG. 10 illustrates an embodiment of providing an insurance company with a count of care providing site visits by a user in the medical data management process.

In operation 1010, a first care providing site server 1001 of a first care providing site visited by a user may create first medical data based on information input by a doctor examining the user. The medical data management apparatus 110 may collect the first medical data created by the first care providing site server 1001.

In operation 1020, a second care providing site server 1002 of a second care providing site visited by the user may create second medical data based on information input by a doctor examining the user. The medical data management apparatus 110 may collect the second medical data created by the second care providing site server 1002.

In operation 1030, the first care providing site server 1001 of the first care providing site may create third medical data based on information input by the doctor examining the user. The medical data management apparatus 110 may collect the third medical data created by the first care providing site server 1001. That is, when the user visits the first care providing site twice, the first care providing site server 1001 may not add medical data created for a second visit to the care providing site to the first medical data previously created but may create the third separate medical data.

In operation 1040, the medical data management apparatus 120 may receive a request for a count of care providing site visits by the user from an insurance company server 140.

In operation 1050, the medical data management apparatus 120 may determine a count of care providing site visits by the user based on a count of the medical data collected in operations 1010, 1020 and 1030. In FIG. 10, since the medical data management apparatus 120 collects three medical data, i.e., the first medical data, the second medical data and the third medical data, the medical data management apparatus 120 may determine the count of care providing site visits by the user to be three.

In operation 1060, the medical data management apparatus 120 may transmit the count of care providing site visits by the user determined in operation 1050 to the insurance company server 140. The medical data management apparatus 120 may manage medical data based on care providing site visits by the user, thereby easily checking the count of care providing site visits by the user.

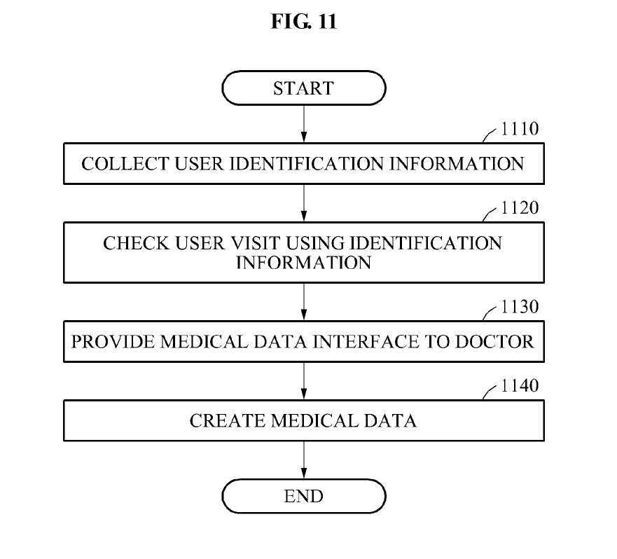

FIG. 11 is a flowchart illustrating a care providing site visit checking method according to an embodiment of the present invention.

Referring to FIG. 11, in operation 1110, the identification information collection unit 211 may collect identification information of a user visiting a care providing site. Here, the identification information collection unit 211 may collect biometric information of the user measured by a sensor as the identification information of the user. Also, when a reader reads the identification information of the user included in a smart card of the user, the identification information collection unit 211 may collect the identification information of the user read by the reader.

In operation 1120, the user visit check unit 212 may check a user's visit to the care providing site using the identification information collected in operation 1110. For example, when the identification information collection unit 211 collects a fingerprint of the user via the sensor, the user visit check unit 212 may retrieve the user corresponding to the collected fingerprint from a database of fingerprints of users and determine that the retrieved user visits the care providing site.

In operation 1130, the medical data interface providing unit 213 may provide a doctor examining the user with a medical data interface for creating medical data of the user whose visit to the care providing site is verified in operation 1120.

In operation 1140, the medical data creation unit 220 may create medical data based on data input via the medical data interface, the identification information of the user, user visit time information and identification information of the care providing site that the user visits, which are provided by the care providing site visit check unit 210 to the doctor.

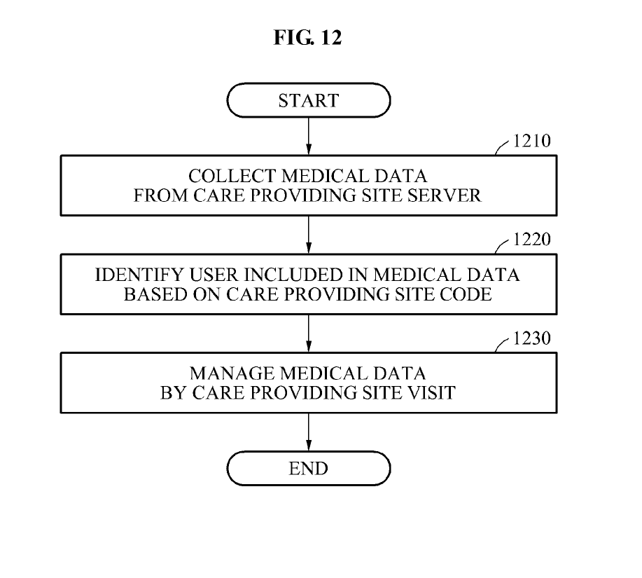

FIG. 12 is a flowchart illustrating an example of a medical data management method according to an embodiment of the present invention.

Referring to FIG. 12, in operation 1210, the medical data collection unit 310 may collect medical data from at least one care providing site server 110. Here, the medical data collection unit 310 may retrieve data from the care providing site server 110 at regular intervals and collect medical data created since the previous retrieval time up to the current retrieval time. Also, the care providing site server 110 creating medical data based on a user visit may transmit the created medical data in real time to the medical data management apparatus 120. Here, the medical data collection unit 310 may collect the medical data transmitted by the care providing site server 110.

In operation 1220, the user identification unit 320 may identify a user included in the medical data collected in operation 1210. Here, the user identification unit 320 may convert a care providing site code matching unified medical data using a user identification code corresponding to the identified user. When the medical data includes information representing a care providing site having the care providing site server 110, the user identification unit 320 may change the care providing site code into a user identification code. The user identification unit 320 may group a plurality of medical data identified to have the same user as the medical data of the identified user.

In operation 1230, the medical data management unit 330 may manage the medical data of the user based on care providing site visits by the user identified in operation 1220. In detail, the medical data management unit 330 may classify each of the medical data collected in operation 1210 into separate files or items to store and manage the medical data. Here, the medical data collected in operation 1210 may be information created whenever the user visits a care providing site.

Further, the medical data management unit 330 may group the medical data of the user based on the user identification code included in the care providing site code changed by the user identification unit 320 or the user identification code changed from the care providing site code.

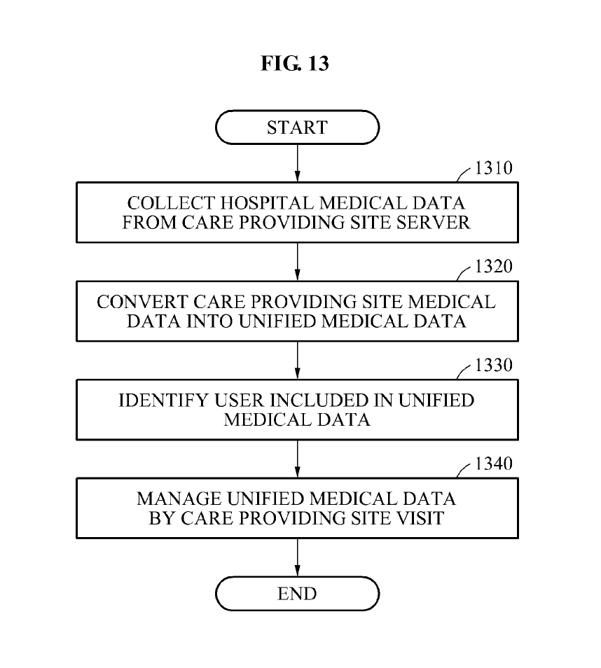

FIG. 13 is a flowchart illustrating another example of a medical data management method according to an embodiment of the present invention.

Referring to FIG. 13, in operation 1310, the medical data collection unit 410 may collect care providing site medical data created in unique formats of care providing sites from care providing site servers associated with the care providing sites. Here, the medical data collection unit 410 may retrieve data from the care providing site servers 110 at regular intervals and collect care providing site medical data since the previous retrieval time up to the current retrieval time. Also, the care providing site servers 110, which create care providing site medical data based on a user visit, may transmit the created care providing site medical data in real time to the medical data management apparatus 120. Here, the medical data collection unit 410 may collect the care providing site medical data transmitted by the care providing site servers 110.

In operation 1320, the unified medical data conversion unit 420 may convert the care providing site medical data collected in operation 1310 into unified medical data in accordance with a standard format based on a care providing site code of a care providing site.

In operation 1330, the user identification unit 430 may identify a user included in the unified medical data converted in operation 1320. Here, the user identification unit 430 may convert a care providing site code matched to the unified medical data using a user identification code corresponding to the identified user. When the unified medical data includes information representing the care providing sites having the care providing site servers 110, the user identification unit 430 may convert the care providing site code into a user identification code.

In operation 1340, the medical data management unit 440 may manage the unified medical data of the user based on care providing site visits by the user identified in operation 1330. Further, the medical data management unit 440 may classify each of the unified medical data converted by the unified medical data conversion unit 420 into separate files or items to store and manage the unified medical data. In addition, the medical data management unit 440 may group the medical data of the user based on the user identification code included in the care providing site code changed by the user identification unit 430 or the user identification code changed from the care providing site code.

The present invention allows checking a care providing site visit by a user and creating new medical data whenever the user visits the care providing site such that a count of care providing site visits by the user can be easily determined.

Also, according to the present invention, medical data can be managed based on care providing site visits by the user such that a count of care providing site visits by the user can be easily determined.

Further, the present invention allows unifying and managing medical data created when the user visits different care providing sites, and providing a care providing site that the user visits with medical data created by the care providing site and other care providing sites when the user visits the care providing site since the medical data of the user created by the other care providing sites can be used.

Furthermore, according to the present invention, when care providing sites use different formats of medical data, care providing site medical data created by each care providing site server are converted into unified medical data in accordance with a standard format and managed, so that contents of medical data written in a unique format of another care providing site may be easily understood.

Although a few exemplary embodiments of the present invention have been shown and described, the present invention is not limited to the described exemplary embodiments. Instead, it would be appreciated by those skilled in the art that that various modifications and variations can be made from the foregoing descriptions.

Therefore, the scope of the present invention is defined not by the aforementioned embodiments but by the appended claims and their equivalents.

What is claimed is:

1. A method for managing medical data, the method comprising:
collecting medical data from a plurality of care provider servers including a first care provider server associated with a first care provider and a second care provider server associated with a second care provider;
identifying a user associated with the collected medical data; and
managing the medical data based on the user's care providing site visit including a first visit to the first care provider and a second visit to the second care provider.

2. The method of claim 1, wherein the identifying the user from the collected medical data includes a user identification information.

3. The method of claim 1, wherein the managing the medical data comprises:
retrieving first medical data collected by the first care providing site server and second medical data collected by the second care providing site server in response to a request of the medical data received from the first care providing site server; and
providing the medical data including the retrieved first medical data and the retrieved second medical data to the first care providing site server.

4. The method of claim 1, wherein the managing the medical data comprises:
identifying a disease category corresponding to symptom information of the user when the symptom information is received from the first care providing site server;
retrieving medical data according to the identified disease category; and
providing the retrieved medical data to the first care providing site server.

5. The method of claim 1, wherein the managing the medical data comprises:
determining a count of the user's care providing site visits based on a count of the medical data in response to a request for the count of the user's care providing site visits received from an insurance company server or an institution server; and
transmitting the determined count of the user's care providing site visits to the insurance company server or the institution server.

6. The method of claim 1, wherein the first care providing site server identifies the user's care providing site visit using identification information of the user visiting the first care providing site and provides a medical data interface for creating or updating the medical data of the user to a doctor examining the user.

7. The method of claim 1, further comprising:
receiving a satisfaction level relating to the user's care providing site visit from a terminal of the user; and
adding the received satisfaction level to the medical data.

8. The method of claim 7, wherein the managing the medical data comprises:
grouping the medical data per each of a plurality of care providing sites based on care providing site codes included in the medical data; and
determining a care providing site to recommend to the user based on a satisfaction level associated with each of the grouped medical data.

9. A method of managing medical data, the method comprising:
collecting medical data from a care providing site server associated with a care providing site;
receiving encounter data related to a user visit to the care providing site from the care providing site server; and
matching the medical data to the encounter data and managing the medical data.

10. An apparatus for managing medical data, the apparatus comprising:
a medical data collection unit configured to collect medical data from a plurality of care providing site servers including a first care providing site server associated with a first care providing site and a second care providing site server associated with a second care providing site;
a user identification unit configured to identify a user associated with the collected medical data; and
a medical data management unit configured to manage the medical data based on the user's care providing site visit including a first visit to the first care providing site and a second visit to the second care providing site.

11. The apparatus of claim 10, wherein the medical data management unit is further configured to provide first medical data collected by the first care providing site server and second medical data collected by the second care providing site server to the first care providing site server in response to a request of the medical data received from the first care providing site server.

12. The apparatus of claim 10, wherein the medical data management unit is further configured to:
identify a disease category corresponding to symptom information of the user when the symptom information is received from the first care providing site server; and
provide medical data retrieved according to the identified disease category to the care providing site server.

13. The apparatus of claim 10, wherein the medical data management unit is further configured to:
determine a count of the user's care providing site visits based on a count of the medical data in response to a request of the count of the user's care providing site visits received from an insurance company server or an institution server; and
transmit the determined count of the user's care providing site visits to the insurance company server or the institution server.

14. The apparatus of claim 10, wherein the first care providing site server identifies the user's care providing site visit using identification information of the user visiting the first care providing site and provides a medical data interface for creating or updating the medical data of the user to a doctor examining the user.

15. The apparatus of claim 10, wherein the medical data management unit is further configured to:
receive a satisfaction level relating to the user's care providing site visit from a terminal of the user; and
add the received satisfaction level to the medical data.

16. The apparatus of claim 15, wherein the medical data management unit is further configured to:
group the medical data per each of a plurality of care providing sites based on care providing site codes included in the medical data; and
determine a care providing site to recommend to the user based on a satisfaction level associated with each of the grouped medical data.

17. An apparatus for managing medical data, the apparatus comprising:
a medical data collection unit configured to collect medical data from a care providing site server associated with a care providing site; and
a medical data management unit configured to:
receive encounter data related to a user visit to the care providing site from the care providing site server; and
match the medical data to the encounter data and manage the medical data.
